(19) United States
(12) Patent Application Publication
(10) Pub. No.: US 2006/0268313 A1
(43) Pub. Date: Nov. 30, 2006

(54) Printing control apparatus and printing control method

(75) Inventor: Seung-sik Yang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co. Ltd., Suwon-si (KR)

(21) Appl. No.: 11/433,526

(22) Filed: May 15, 2006

(30) Foreign Application Priority Data
May 20, 2005 (KR) 2005-42387

(51) Int. Cl. G06K 15/00; G06F 15/00

(52) U.S. Cl. 358/1.14; 358/1.15; 358/1.2

(57) ABSTRACT

A printing control apparatus and printing control method thereof are provided. The printing control method includes: storing a Meta file corresponding to an image data, converting the stored Meta file into a print data, if a memory error occurs in the printing apparatus during printing of the converted data, determining whether a printer driver is preset to a raster mode, and if the printer driver is not, changing the printer driver to the raster mode and converting the stored file into another print data, and if the printer driver is preset to the raster mode, lowering a preset resolution of the printer driver before converting the stored Meta file into another print data with the lowered resolution. Lowering the resolution of the print data decreases the print data size such that the memory error due to a shortage of memory capacity can be solved and print speeds can be enhanced.

### CROSS-REFERENCE TO RELATED APPLICATIONS

This application claims the benefit of Korean Application No. 2005-42387, filed May 20, 2005, in the Korean Intellectual Property Office, the disclosure of which is incorporated herein by reference.

### BACKGROUND OF THE INVENTION

1. Field of the Invention

Aspects of the present invention relate to a printing control apparatus and a printing control method. More particularly, aspects of the present invention relate to a printing control apparatus which can resolve a memory error due to a shortage of memory capacity, and a printing control method to resolve a memory error due to a shortage of memory capacity.

2. Description of the Related Art

Generally, to print a document from a printing control apparatus such as a computer via a printing apparatus such as a printer, the printing control apparatus needs to have a printer driver for driving the printing apparatus.

Image data produced by an application program of the computer is converted by the printer driver into print data recognizable by the printer. Postscript and print control language (PCL) are the most widely used languages for expressing the print data in a format recognizable by the printer.

The printer driver typically converts path, bitmap, and font elements into a command language such as postscript or PCL, using functions of a graphic device interface (GDI) of an operating system, such as MS Windows. The GDI provides mathematical functions and relevant structures usable in application programs for graphic output to displays, printers, and other devices, and to support the printer driver to generate print images in the computer for sending to the printing apparatus.

As the printer driver converts the image data to be printed into the command language, such as postscript or PCL, firmware of the printer re-analyzes the command language instructions generated by the print driver and restores the instructions to the original status to generate printable images.

If the content of data produced by a user is complicated, the command language from the printer driver to the printer may be tens of thousands through hundreds of thousands of instructions long. Accordingly, the printer memory capacity may become over burdened while analyzing the command language of tens of thousands through hundreds of thousands of instructions, the time for analyzing may become extensive, and execution of the print job may be significantly delayed. Particularly, if the command language instructions are concentrated in a certain area due to a concentration of complicated data in that certain area, then memory errors such as band error or memory overflow may occur due to the shortage of memory capacity for the firmware of the printer to analyze the command language instructions and restore them to the original state.

If a memory error occurs, it is not possible to print the print data from the printing apparatus.

### SUMMARY OF THE INVENTION

Accordingly, aspects of the present invention provide a solution to the above and/or other problems, among other benefits. An aspect of the present invention provides a printing control apparatus and a method for controlling the same which can solve a memory error due to a shortage of memory capacity of a printing apparatus.

Accordingly an aspect of the present invention is achieved by providing a method of printing control with a printing control apparatus having a printer driver to convert an image data into a print data interpretable by a printing apparatus, comprising: storing a Meta file corresponding to a certain image data, converting the stored Meta file into the print data, determining whether a printer memory error occurs in the printing apparatus in a process of a printing job of the converted print data, lowering a preset resolution of the printer driver if a memory error occurs, and converting the stored Meta file into the print data with the lowered resolution.

According to an aspect of the invention, the method further comprises displaying a message asking as to whether to lower the preset resolution of the printer driver if the memory error occurs.

According to an aspect of the invention, the method further comprises terminating the print job if the option to lower the preset resolution according to the displayed message is not selected.

According to an aspect of the invention, the Meta file is an Enhanced Meta File.

According to another aspect of the present invention, a method of printing control using a printing control apparatus with a printer driver to convert an image data into a print data interpretable by a printing apparatus, comprises: storing a Meta file corresponding to a certain image data; converting the stored Meta file into the print data; determining whether a printer memory error occurs in the printing apparatus in a process of a printing job of the converted print data; and changing the printer driver to a raster mode and converting the stored Meta file into a second print data if the memory error occurred.

According to another aspect of the present invention, the method of controlling a printer of a printing control apparatus with a printer driver converting an image data into a print data interpretable by a printing apparatus, comprises storing a Meta file corresponding to a certain image data, converting the stored Meta file into the print data, determining if the printer driver is preset to a raster mode, determining if a memory error occurs in the printing apparatus in a process of a printing job of the converted print data, and if a memory error occurs changing the printer driver to the raster mode if the printer driver is not preset to the raster mode and converting the stored Meta file into a second print data.

According to an aspect of the invention the method further comprises lowering a preset resolution of the printer driver if the printer driver is preset to the raster mode, and converting the stored Meta file into a print data with the lowered resolution.

According to an aspect of the invention the method further comprises displaying a message asking as to whether to lower the preset resolution of the printer driver, if the memory error occurs.

According to an aspect of the invention, the method further comprises terminating the printing job if the option to lower the preset resolution according to the displayed message is not selected.

According to an aspect of the present invention, a printing control apparatus comprises a memory to store a Meta file corresponding to a certain image data, and a print driver to convert the Meta file stored in memory into a second print data with a lower resolution than a resolution applied to an initial print data if a memory error occurs in a printing apparatus in a process of a printing job of the initial print data corresponding to the Meta file.

According to an aspect of the invention, the apparatus further comprises a control part to change the preset resolution of the printer driver to a lower level if the option is selected to lower the preset resolution in response to the message displayed asking as to whether to lower a preset resolution of the printer driver.

According to an aspect of the invention the apparatus further comprises a graphic device interface (GDI) to generate the Meta file corresponding to the image data, and a spooler to store the generated Meta file to the memory and to read out the Meta file of the memory to perform a playback to the printer driver if the memory error occurs.

According to an aspect of the invention the spooler comprises a language monitor to determine whether the memory error occurs in the printing apparatus, a spooler control part to perform a playback of the Meta file to the printer driver if an error signal corresponding to the memory error is received from the language monitor, and a port monitor to transmit the print data from the printer driver to the printing apparatus.

According to another aspect of the present invention, a printing control apparatus is provided comprising a memory to store a Meta file corresponding to a certain image data, a printer driver to convert the Meta file of the memory into an initial print data, and a control part to control the printer driver to set it to a raster mode and to convert the Meta file of the memory into a second print data if a memory error occurs in a printing apparatus in a process of a printing job of the initial converted print data.

According to another aspect of the present invention, a printing control apparatus comprises a memory to store a Meta file corresponding to a certain image data, a printer driver to convert the Meta file of the memory into an initial print data, and a control part to set the printer driver to a raster mode and to control the printer driver to convert the Meta file of the memory into a second print data if a memory error occurs in a printing apparatus in the process of the printing job of the converted initial print data when the printer driver is not preset to a raster mode.

According to an aspect of the invention if the printer driver is preset to the raster mode, the control part displays a message asking as to whether to lower a preset resolution of the printer driver, and if the option is selected to lower the preset resolution, the control part changes the preset resolution of the printer driver to a lower resolution and controls the printer driver to convert the Meta file of the memory into a third print data according to the lowered resolution.

According to an aspect of the invention the apparatus further comprises a graphic device interface (GDI) to generate the Meta file corresponding to the image data, and a spooler to store the generated Meta file to the memory and to read out the Meta file of the memory to perform a playback to the printer driver if the memory error occurs.

According to an aspect of the invention the spooler comprises a language monitor to sense whether the memory error occurs in the printing apparatus, a spooler control part to perform playback of the Meta file to the printer driver if an error signal corresponding to the memory error is received from the language monitor, and a port monitor to transmit the print data from the printer driver to the printing apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a printing control apparatus according to an embodiment of the present invention;

FIG. 2 is a detailed block diagram of partial members of the printing control apparatus of FIG. 1; and

FIG. 3 is a flowchart of a printing control method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

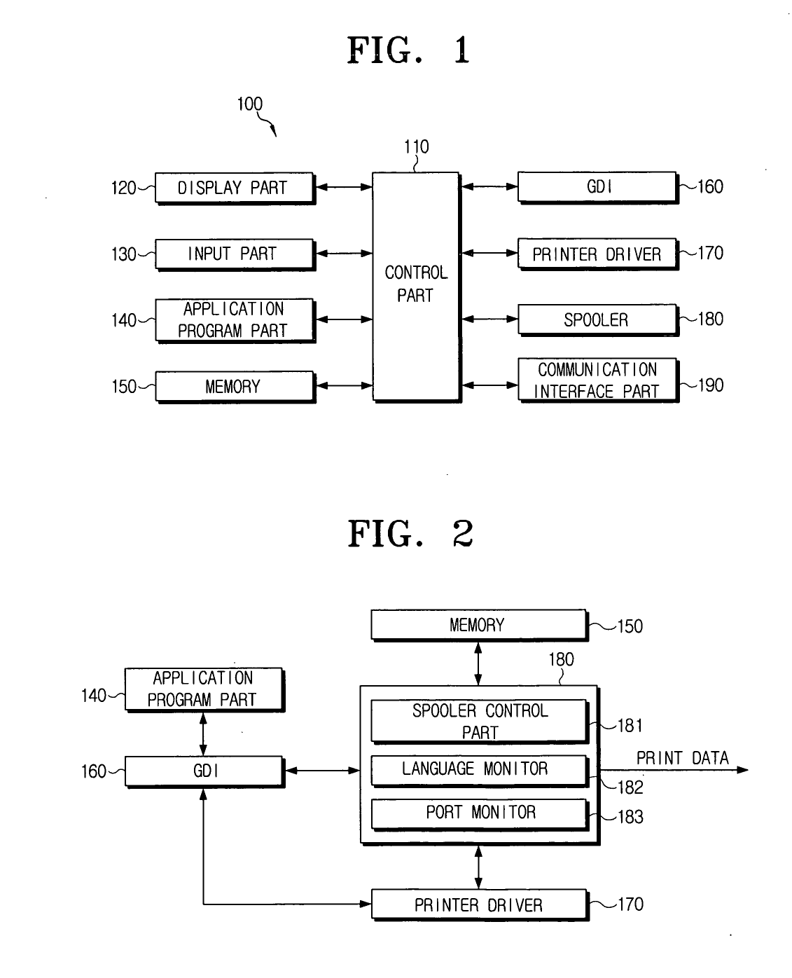

FIG. 1 is a block diagram of a printing control apparatus according to an embodiment of the present invention, and FIG. 2 is a detailed block diagram of partial members of the printing control apparatus of FIG. 1. Referring to FIGS. 1 and 2, the printing control apparatus 100 according to an embodiment of the present invention comprises a control part 110, a display part 120, an input part 130, an application program part 140, a memory 150, a graphic device interface (GDI) 160, a printer driver 170, a spooler 180, and a communication interface part 190.

The display part 120 displays various pieces of information provided from the printing control apparatus 100. An example of the display part 120 is a monitor such as a cathode ray tube (CRT) or a liquid crystal display (LCD). The display part 120 according to an embodiment of the present invention, displays under control of the control part 110 a message asking whether to lower a preset resolution of the printer driver 170 as a request to receive an input selection from a user, if a memory error such as a band error or a memory overflow occurs in the process of a printing job in a printing apparatus (not shown). While described as a monitor, it is understood that other displays can be used and can be integrated into a printer or connected to a computer.

The input part 130 is a user interface and comprises a plurality of function keys, such as a keyboard and a mouse, for setting and selecting functions of the printing control apparatus 100. More specifically, the input part 130 according to an embodiment of the present invention receives the user's selection regarding whether to lower the preset resolution of the printer driver 170, if a memory error occurs in the process of a printing job. However, it is understood that other input devices can be used, such as computer mice, remote controllers, touch screen displays, etc. The input part 130 can be integrated into the printer or connected to a computer.

The communication interface part 190 is provided to connect the printing control apparatus 100 to an external device. A parallel port, a USB port, and a wireless module are examples of connections which may be applied to the communication interface part 190. The communication interface part 190 according to an embodiment of the present invention connects to the printing apparatus in order to exchange information data related to printing therethrough, such that the data related to printing are transmitted and received through the communication interface part 190.

The application program part 140 may be implemented as a word processor program, a database program, an image edition program, a browser, etc. Any program may be implemented as the application program part 140 as long as a printing command to print the image data to be printed can be input by using the program.

The memory 150 stores thereto the image data to be printed generated by various programs and application programs to implement functions of the printing control apparatus 100. According to an embodiment of the present invention, the memory 150 stores thereto a Meta file via a spooler 180 as the Meta file is generated from the GDI 160. While described as a Meta file, it is understood that the file can be a Windows Meta file, a Computer Graphics Meta file, or any like file which describes or specifies another file (often in relation to graphics).

The GDI 160 is an interface to draw a graphic object. In other words, the GDI 160 is a component of the operating system (such as Windows, Lynux, OS X) for implementing graphic functions such as drawing lines and controlling colors, and which generates a Meta file of the image data to be printed. The image data is generated and edited in the application program part 140 and converted by the GDI 160 to the Meta file in order to transmit the image data to the spooler 180. The Meta file is an intermediate data used to generate the print data corresponding to the image data to be printed. In the process of generating the print data corresponding to the image data to be printed, the Meta file for the print data is generated, and then the print data is generated from the Meta file. The Meta file may be an enhanced Meta file. However, it is understood that the GDI 160 can be a separate program apart from the operating system.

The spooler 180 spools to the memory 150 the Meta file generated from the GDI 160 and the print data generated from the printer driver 170. The spooler 180 provides the printer driver 170 with the spooled Meta file buffered by a certain amount over the GDI 160, and sequentially transmits the spooled print data to the printing apparatus. The spooler 180, according to an embodiment of the present invention, plays back the Meta file of the memory 150 to re-provide it to the printer driver 170, if the memory error such as the band error or the memory overflow occurs during the process of printing in the printing apparatus.

According to an aspect of the invention, the spooler 180 comprises a spooler controller 181, a language monitor 182, and a port monitor 183. The language monitor 182 includes a communication interface with the printing apparatus to receive the information message on the job status of the printing apparatus. If the language monitor 182, according to an embodiment of the present invention, senses the memory error generated in the printing apparatus while analyzing the print data and restoring the print data to the original status during the process of printing, the language monitor 182 transmits an error signal corresponding to the memory error to a spooler control part 181 and the control part 110.

The port monitor 183 transmits the print data spooled according to the job status of the printing apparatus via the communication interface part 190 to the printing apparatus by a certain amount at a time. However, it is understood that, if the memory 150 and/or GDI 160 is within the printing apparatus, the print data need not be sent via the communication interface part 160.

The spooler control part 181 performs playback of the Meta file of the memory 150 to re-provide the printer driver with the image data if the error signal is received from the language monitor 182.

The printer driver 170 converts the Meta file into the print data recognizable by the printing apparatus and transmits the converted file to the spooler 180. For example, converted print data can be an output file in the form of postscript (PS) or a Hewlett-Packard (HP) printer control language (PCL) file. According to an aspect of the present invention, the printer driver 170 converts the Meta file played back from memory 150 into the print data in the form of a bitmap if a raster mode is set by the control part 110. If the memory error further occurs, the printer driver 170 applies a lower resolution to convert the Meta file into the print data. If the raster mode applies to convert the Meta file into the print data in the form of a bitmap, or if a lower resolution than the previous print attempt is applied to convert the Meta file into the print data as described above, then less memory is needed while processing the print data in the printing apparatus so that the band error or the memory over flow may be prevented and printing speed may improve.

The control part 110 controls general operations of individual members of the printing control apparatus 100 which are the display part 120, the input part 130, the application program part 140, the memory 150, the GDI 160, the printer driver 170, the spooler 180, and the communication interface part 190. The control part can be part of a computer, a personal digital assistant, electronic appliance using the printer device and/or may be included in the printer device itself.

The control part 110, according to an embodiment of the present invention, determines if the printer driver 170 is preset to the raster mode when the error signal is received from the language monitor 182 signaling a generation of the memory error. If not, the control part 110 changes the printer driver 170 to the raster mode to convert the Meta file played back from memory 150 into the print data in bitmap form. Additionally, if the printer driver 170 is preset to the raster mode, the control part 110 displays on the display part 120 a message asking whether to lower the preset resolution of the printer driver 170 to receive a response to the message from a user. If the user selects a lowering of the resolution, the control part 110 lowers the resolution that the printer driver 170 applies to the playback-performed Meta file so as to convert the Meta file into the print data. If a user does not select to lower the resolution, the control part 110 may terminate the printing job for the print data with the memory error.

In the present embodiment, the control part 110 determines if the printer driver 170 is preset to the raster mode. If so, the control part 110 lowers the preset resolution of the printer driver 170. However, this embodiment should not be considered as limiting the present invention thereto. The control part 110 may lower the preset resolution of the printer driver 170 without a determination as to whether the raster mode is set. In addition, if the memory error occurs in the printing apparatus, the printer driver 170 can be directly changed to the raster mode to convert the pre-stored Meta file into the print data.

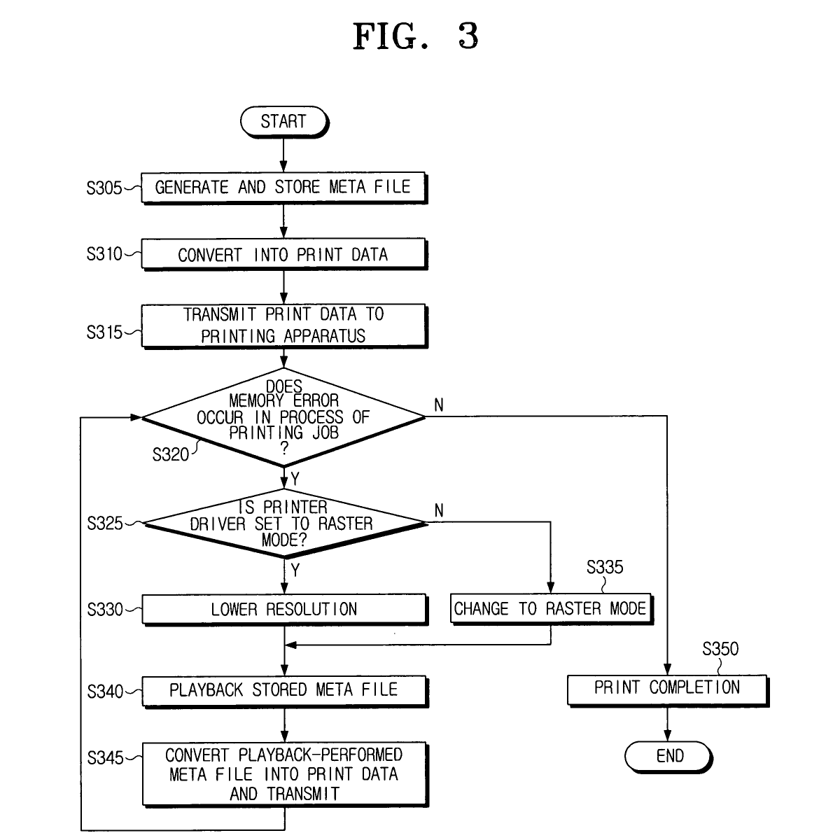

FIG. 3 is a flowchart of a printing control method according to an embodiment of the present invention.

Referring to FIGS. 1 and 3, as printing commands to print the image data generated and edited in the application program part 140 are received by the control part 110 via the input part 130 from a user, the GDI 160 produces the Meta file for the print-commanded image data and the spooler 180 spools the Meta file from the GDI 160 to store it to the memory 150 (S305).

The printer driver 170 converts the Meta file from the spooler 180 into the print data (S310), and the spooler 180 sequentially transmits the converted print data via the communication interface part 190 to the external printing apparatus by a certain amount at a time (S315) so as to complete the printing job as to the print data transmitted to the printing apparatus (not shown) (S350).

If the memory error occurs in the printing apparatus while printing the transmitted print data (S320), the control part 110 determines if the printer driver 170 is preset to the raster mode (S325).

If the control part 110 determines that the printer driver 170 is preset to the raster mode, the control part 110 lowers the preset resolution of the printer driver 170 (S330). Otherwise, the control part 110 changes the print mode of the printer driver 170 to the raster mode if the printer driver 170 was not preset to the raster mode (S335). Since a user may not wish to perform printing with the lowered resolution, the control part 110 displays on the display part 120 a message asking as to whether to lower the resolution prior to lowering the preset resolution of the printer driver 170 in S330. If a user selects the lowering of the resolution, the preset resolution of the printer driver 170 may be changed to a lower level, and if a user does not select the lowering of the resolution, the printing job for the print data with the memory error may be terminated. However, this query is not required in all aspects of the invention.

The spooler 180 allows the printer driver 170 to play back the Meta file stored in the memory 150 (S340). Then, if the resolution lowers in S330, the printer driver 170 applies the lowered resolution to convert the playback-performed Meta file into the print data with a lower resolution. If the printer driver 170 is set to the raster mode in S335, the printer driver 170 converts the playback-performed Meta file into the print data in the bitmap form to transmit via the spooler 180 to the external printing apparatus (S345).

Thereafter, S320 through S345 are repeated until the printing job is completed in the printing apparatus without incurring the memory error to the transmitted print data (S350).

In the present embodiment, the control part 110 determines if the printer driver 170 is preset to the raster mode (S325), and if so, the preset resolution of the printer driver 170 is lowered in response to a memory error. However, the preset resolution of the printer driver 170 may be directly lowered (S330) without S325. Additionally, the printer driver 170 may be directly changed to the raster mode (S335) to convert the pre-stored Meta file into the print data without S325 which determines whether the printer driver 170 is set to the raster mode in response to the memory error occurrence in the printing apparatus.

While not required in all aspects, portions of the method can be implemented using computer software and/or firmware encoded on one or more computer readable media to be implemented on one or more computers.

As described above, according to embodiments of the present invention, if the memory error occurs while analyzing and restoring the pre-transmitted print data in the printing apparatus, the pre-stored Meta file is played back to the printer driver 170 and converted into the print data in the lower resolution or bitmap form which needs relatively less memory during the process of executing the printing job in the printing apparatus. Then, the re-converted print data is transmitted to the printing apparatus. Therefore, the memory error due to the shortage of memory capacity of the printing apparatus can be solved, and the printing speed may be increased.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of printing to a printing apparatus using a print controller apparatus, comprising:
sending print data to the printing apparatus;
detecting an error in the printing apparatus due to the sent print data; and
reducing a size of the print data when the error is detected.

2. The method of claim 1, wherein:
the detecting the error comprises detecting a memory capacity error in the printing apparatus due to the sent print data; and
the reducing the size comprises reducing a resolution of the print data when the memory capacity error is detected.

3. The method of claim 1, wherein:
the detecting the error comprises detecting a memory capacity error in the printing apparatus due to the sent print data; and
the reducing the size comprises changing the print data to a raster mode when the memory capacity error is detected.

4. The method of claim 1, further comprising:
storing the print data before sending the print data to the printing apparatus,
wherein the reducing the size comprises reducing the size of the stored print data when the error is detected in the printing apparatus due to the sent print data; and sending the stored print data with the reduced size to the printing apparatus.

5. The method as claimed in claim 1, wherein the reducing the size of the print data converts the print data into an Enhanced Meta file to store.

6. The method as claimed in claim 1, further comprising:
displaying a message requesting user input as to whether to lower the preset resolution of the printer driver after the memory error occurs.

7. The method as claimed in claim 6, further comprising:
terminating the printing job if it is not selected to lower the preset resolution according to the displayed message.

8. A print control apparatus comprising:
a printer driver to send print data to a printing apparatus;
a language monitor to detect an error in the printing apparatus due to the sent print data; and
a print data size reduction part to reduce a size of the print data when the error occurs due to the sent print data.

9. The print control apparatus of claim 8, wherein:
the error detected by the language monitor comprises a memory capacity error in the printing apparatus due to the sent print data; and
the print data size reduction part reduces a resolution of the print data when the memory capacity error occurs due to the sent print data to reduce the size of the print data.

10. The print control apparatus of claim 8, wherein the print data size reduction part changes the printer driver to a raster mode when the error occurs due to the size of the print data to reduce the size of the print data.

11. The print control apparatus of claim 8, further comprising:
a memory to store image data to send to the printer driver, wherein the print data size reduction part recalls the stored image data and reduces the size of the recalled image data.
